(19) United States
(12) Patent Application Publication
(10) Pub. No.: US 2022/0261701 A1
(43) Pub. Date: Aug. 18, 2022

(54) SERVICE MANAGEMENT DEVICE, SERVICE MANAGEMENT SYSTEM, AND SERVICE MANAGEMENT METHOD

(71) Applicant: TOYOTA JIDOSHA KABUSHIKI KAISHA, Toyota-shi (JP)

(72) Inventors: Ryo MURAKAMI, Susono-shi (JP); Yuji TACHIBANA, Nisshin-shi (JP); Minoru NAKADORI, Toyota-shi (JP); Daiki KANEICHI, Shinagawa-ku (JP)

(73) Assignee: TOYOTA JIDOSHA KABUSHIKI KAISHA, Toyota-shi (JP)

(21) Appl. No.: 17/576,158

(22) Filed: Jan. 14, 2022

(30) Foreign Application Priority Data
Feb. 17, 2021 (JP) 2021-023736

(51) Int. Cl. G06Q 10/02; G06Q 50/30; G08G 1/123; G08G 1/00

(52) U.S. Cl. CPC G06Q 10/02; G08G 1/202; G08G 1/123; G06Q 50/30

(57) ABSTRACT

A service management device includes a communicator configured to receive, from a terminal device, request data indicating a request to transport a user, and a controller configured to, when the request data is received by the communicator, determine a transportation vehicle configured to transport the user by referring to service data. The service data indicates order in which a plurality of vehicles configured to sequentially depart from a base and move toward a common destination is expected to arrive at a waiting location where the user is waiting, and availabilities of vehicles before arrival at the waiting location among the plurality of vehicles.

### CROSS-REFERENCE TO RELATED APPLICATION

This application claims priority to Japanese Patent Application No. 2021-023736 filed on Feb. 17, 2021, incorporated herein by reference in its entirety.

### BACKGROUND

### 1. Technical Field

The present disclosure relates to a service management device, a service management system, and a service management method.

### 2. Description of Related Art

Japanese Unexamined Patent Application Publication No. 2020-030496 (JP 2020-030496 A) discloses a device configured to determine the order of users to get on an on-demand bus based on seat availability information indicating the seat availability of the bus.

### SUMMARY

When a request is made to ride an on-demand bus but cannot be fulfilled because the oncoming bus has no available seat, the user may suffer inconvenience.

The present disclosure provides a service management device, a service management system, and a service management method for improvement in user's convenience.

A first aspect of the present disclosure relates to a service management device. The service management device includes a communicator configured to receive, from a terminal device, request data indicating a request to transport a user, and a controller configured to, when the request data is received by the communicator, determine a transportation vehicle configured to transport the user by referring to service data. The service data indicates order in which a plurality of vehicles configured to sequentially depart from a base and move toward a common destination is expected to arrive at a waiting location where the user is waiting, and an availability of a vehicle before arrival at the waiting location among the plurality of vehicles.

In the first aspect, the controller may be configured to update the service data for an availability of the transportation vehicle when any one of the vehicles is determined as the transportation vehicle.

In the first aspect, the controller may be configured to, when the request data is received by the communicator, determine whether the controller selects a first arriving vehicle as the transportation vehicle, the first arriving vehicle being a vehicle expected to arrive at the waiting location subsequently among the plurality of vehicles based on an availability of the first arriving vehicle. The controller may be configured to, when the controller does not select the first arriving vehicle, determine whether the controller selects a second arriving vehicle as the transportation vehicle, the second arriving vehicle being a vehicle expected to arrive at the waiting location later than the first arriving vehicle among the plurality of vehicles based on an availability of the second arriving vehicle.

In the first aspect, when the first arriving vehicle has departed from the base, the second arriving vehicle may be moving closer to the base than the first arriving vehicle, or may be on standby at the base. When the first arriving vehicle is on standby at the base, the second arriving vehicle may be on standby at the base and scheduled to depart later than the first arriving vehicle.

In the first aspect, the communicator may be configured to, when a vehicle on standby at the base is determined as the transportation vehicle by the controller, transmit instruction data to the transportation vehicle, the instruction data being data indicating an instruction to depart from the base.

In the first aspect, the controller may be configured to determine the first arriving vehicle and the second arriving vehicle as the transportation vehicles when a plurality of users including the user is present and the first arriving vehicle has an availability for a part of the users.

In the first aspect, the controller may be configured to, when the request data is received by the communicator, determine whether the controller selects an arriving vehicle as the transportation vehicle, the arriving vehicle being a vehicle expected to arrive at the waiting location subsequently among the plurality of vehicles based on an availability of the arriving vehicle. The controller may be configured to, when the controller does not select the arriving vehicle, determine whether the controller selects a shareable vehicle as the transportation vehicle, the shareable vehicle being different from the vehicles and configured to move toward an individual destination.

In the first aspect, the communicator may be configured to, when the shareable vehicle is determined as the transportation vehicle by the controller, transmit response data to the terminal device, the response data indicating an instruction to move from the waiting location toward a riding location where the user is expected to get in the shareable vehicle.

In the first aspect, the communicator may be configured to, when the shareable vehicle is determined as the transportation vehicle by the controller, transmit, to the transportation vehicle, instruction data indicating an instruction to move toward the waiting location.

In the first aspect, the controller may be configured to determine the arriving vehicle and the shareable vehicle as a plurality of the transportation vehicles when a plurality of users including the user is present and the arriving vehicle has an availability for a part of the users.

A second aspect of the present disclosure relates to a service management system. The service management system includes a terminal device, a plurality of vehicles configured to sequentially depart from a base and move toward a common destination, and a service management device. The service management device includes a communicator configured to receive, from the terminal device, request data indicating a request to transport a user, and a controller configured to, when the request data is received by the communicator, determine a transportation vehicle configured to transport the user by referring to service data. The service data indicates order in which the vehicles configured to sequentially depart from the base and move toward the common destination are expected to arrive at a waiting location where the user is waiting, and an availability of a vehicle before arrival at the waiting location among the plurality of vehicles.

In the second aspect, the service management system may include a shareable vehicle different from the vehicles and configured to move toward an individual destination. The controller may be configured to, when the request data is received by the communicator, determine whether the controller selects an arriving vehicle as the transportation vehicle, the arriving vehicle being a vehicle expected to arrive at the waiting location subsequently among the plurality of vehicles based on an availability of the arriving vehicle. The controller may be configured to, when the controller does not select the arriving vehicle, determine whether the controller selects the shareable vehicle as the transportation vehicle.

In the second aspect, the shareable vehicle may be configured to, when the individual destination is identical to the common destination and the shareable vehicle is left at the individual destination after driving, autonomously move to follow a vehicle that has arrived at the common destination among the plurality of vehicles.

In the second aspect, the terminal device may be configured to transmit the request data to the service management device when the user is detected at the waiting location.

A third aspect of the present disclosure relates to a service management method. The service management method includes transmitting, from a terminal device to a service management device, request data indicating a request to transport a user, and determining, when the request data is received by the service management device, a transportation vehicle configured to transport the user by referring to service data. The service data indicates order in which a plurality of vehicles configured to sequentially depart from a base and move toward a common destination is expected to arrive at a waiting location where the user is waiting, and an availability of a vehicle before arrival at the waiting location among the plurality of vehicles.

In the third aspect, the service management method may include updating the service data for an availability of the transportation vehicle when any one of the vehicles is determined as the transportation vehicle.

In the third aspect, the determining the transportation vehicle may have determining, when the request data is received by the service management device, whether to select a first arriving vehicle as the transportation vehicle, the first arriving vehicle being a vehicle expected to arrive at the waiting location subsequently among the plurality of vehicles based on an availability of the first arriving vehicle. The determining the transportation vehicle may include determining, when the first arriving vehicle is not selected, whether to select a second arriving vehicle as the transportation vehicle, the second arriving vehicle being a vehicle expected to arrive at the waiting location later than the first arriving vehicle among the plurality of vehicles based on an availability of the second arriving vehicle.

In the third aspect, when the first arriving vehicle has departed from the base, the second arriving vehicle may be moving closer to the base than the first arriving vehicle, or may be on standby at the base. When the first arriving vehicle is on standby at the base, the second arriving vehicle may be on standby at the base and scheduled to depart later than the first arriving vehicle.

In the third aspect, the determining the transportation vehicle may have determining, when the request data is received by the service management device, whether to select an arriving vehicle as the transportation vehicle, the arriving vehicle being a vehicle expected to arrive at the waiting location subsequently among the plurality of vehicles based on an availability of the arriving vehicle. The determining the transportation vehicle may include determining, when the arriving vehicle is not selected, whether to select a shareable vehicle as the transportation vehicle, the shareable vehicle being different from the vehicles and configured to move toward an individual destination.

According to the first aspect, the second aspect, and the third aspect of the present disclosure, the user's convenience is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating the configuration of a system according to an embodiment of the present disclosure;

FIG. 2 is a diagram illustrating a user and a plurality of vehicles according to one example;

FIG. 3 is a table illustrating data registered in a database according to the example of FIG. 2;

FIG. 4 is a block diagram illustrating the configuration of a service management device according to the embodiment of the present disclosure;

FIG. 5 is a block diagram illustrating the configuration of a terminal device according to the embodiment of the present disclosure;

FIG. 6 is a diagram illustrating specifications of a cabin of each vehicle according to the embodiment of the present disclosure;

FIG. 7 is a flowchart illustrating operations of the service management device according to the embodiment of the present disclosure;

FIG. 8 is a flowchart illustrating operations of the terminal device according to the embodiment of the present disclosure;

FIG. 9 is a diagram illustrating a user and a plurality of vehicles according to one example;

FIG. 10 is a table illustrating data registered in the database according to the example of FIG. 9;

FIG. 11 is a diagram illustrating users and a plurality of vehicles according to one example;

FIG. 12 is a diagram illustrating the configuration of a system according to a modified example of the embodiment of the present disclosure; and

FIG. 13 is a flowchart illustrating operations of a service management device according to the modified example of the embodiment of the present disclosure.

### DETAILED DESCRIPTION OF EMBODIMENTS

Some embodiments of the present disclosure are described below with reference to the drawings.

In the drawings, the same or corresponding parts are represented by the same reference symbols. In the description of the embodiments, description of the same or corresponding parts is omitted or simplified as appropriate.

One embodiment of the present disclosure is described.

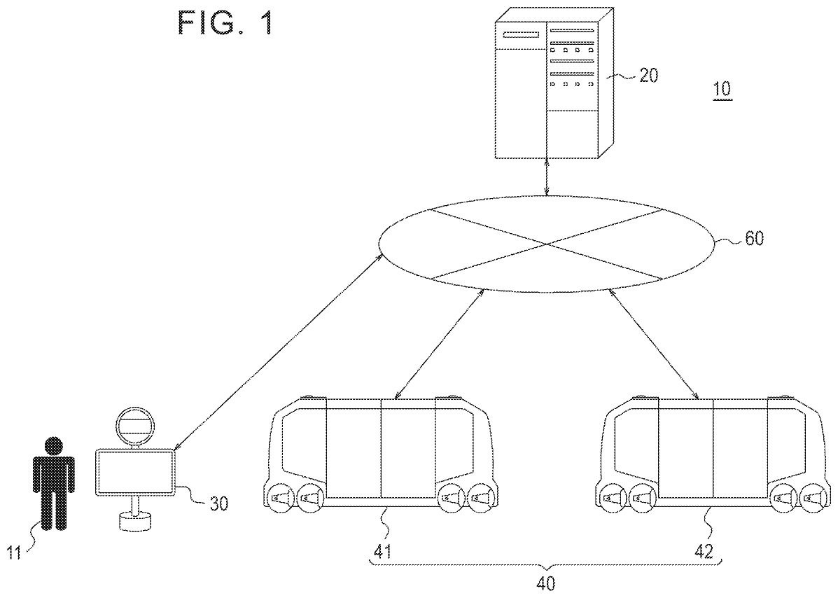

The configuration of a system 10 according to this embodiment is described with reference to FIG. 1.

The system 10 according to this embodiment includes at least one service management device 20, at least one terminal device 30, and a plurality of vehicles 40. The service management device 20 is communicable with the terminal device 30 and the vehicles 40 via a network 60. The terminal device 30 may be communicable with the vehicles 40 via the network 60.

The service management device 20 is installed in a facility such as a data center. The service management device 20 is a computer such as a server belonging to a cloud computing system or other computing systems.

The terminal device 30 is installed at a bus stop and used by at least one user 11. Examples of the terminal device 30 include digital signage.

Each vehicle 40 is any type of automobile such as a gasoline vehicle, a diesel vehicle, an HV, a PHV, an EV, or an FCV. “HV” is an abbreviation for “hybrid vehicle”, and may be referred to as “HEV” (Hybrid Electric Vehicle). “PHV” is an abbreviation for “plug-in hybrid vehicle”, and may be referred to as “PHEV” (Plug-in Hybrid Electric Vehicle). “EV” is an abbreviation for “electric vehicle”, and may be referred to as “BEV” (Battery Electric Vehicle). “FCV” is an abbreviation for “fuel cell vehicle”, and may be referred to as “FCEV” (Fuel Cell Electric Vehicle). In this embodiment, each vehicle 40 is an AV, but may be driven by a driver, or driving may be automated at any level. “AV” is an abbreviation for “autonomous vehicle”. For example, the automation level is any one of Level 1 to Level 5 defined by SAE. “SAE” is an abbreviation for “Society of Automotive Engineers”. Each vehicle 40 may be a MaaS vehicle. “MaaS” is an abbreviation for “Mobility as a Service”.

The network 60 includes the Internet, at least one WAN, at least one MAN, or any combination of those networks. “WAN” is an abbreviation for “wide area network”. “MAN” is an abbreviation for “metropolitan area network”. The network 60 may include at least one wireless network, at least one optical network, or any combination of those networks. Examples of the wireless network include an ad hoc network, a cellular network, a wireless LAN, a satellite communication network, and a terrestrial microwave network. “LAN” is an abbreviation for “local area network”.

As one modified example of this embodiment, the terminal device 30 may be held by the user 11 instead of being installed at the bus stop. In this modified example, the terminal device 30 is a mobile device such as a mobile phone, a smartphone, or a tablet.

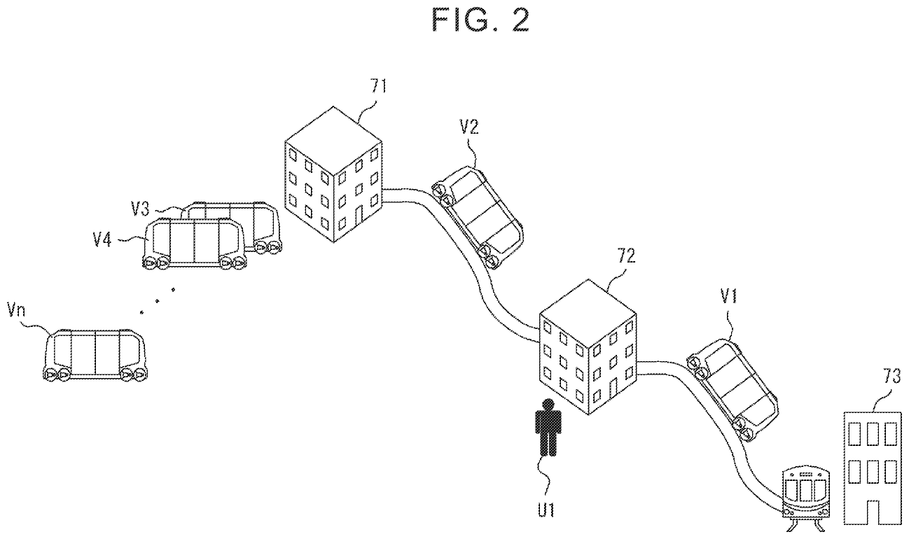

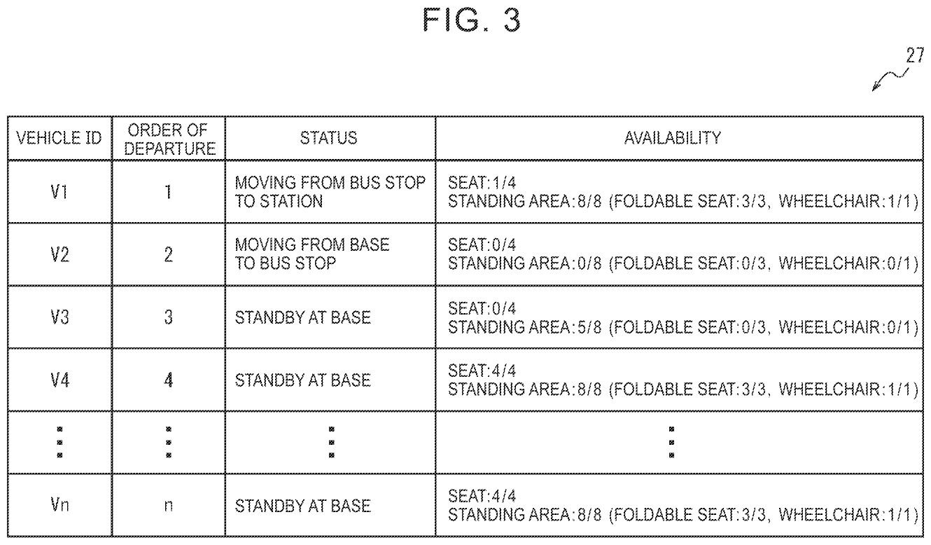

An overview of this embodiment is described with reference to FIG. 1, FIG. 2, and FIG. 3.

The vehicles 40 sequentially depart from a base 71 and move toward a common destination 73. In the example of FIG. 2, vehicles V1, V2, . . . and Vn that are EVs serving as the vehicles 40 operate as on-demand buses configured to transport residents, commuters, and visitors in a smart city. The number “n” is any integer equal to or larger than 2. In this example, the number “n” is an integer equal to or larger than 5. The base 71 is a bus garage. The base 71 includes apparatuses for maintenance, repair, and charging of the vehicles. The destination 73 is a nearest railroad station in the smart city.

The terminal device 30 transmits request data D1 to the service management device 20. The request data D1 indicates a request to transport the user 11. The user 11 waits at a waiting location 72. In the example of FIG. 2, a user U1 who is a commuter in the smart city serving as the user 11 is waiting for a bus at the waiting location 72 to go home from the smart city. The waiting location 72 is a bus stop in the smart city. The bus stop may be an entrance of an apartment in the smart city. The terminal device 30 is installed at the waiting location 72. In this example, the waiting location 72 is a fixed location, but may arbitrarily be designated by the user 11. When the vehicles 40 move along a predetermined route from the base 71 to the destination 73, the waiting location 72 may be limited to any location on the route.

When the request data D1 is received, the service management device 20 determines a transportation vehicle to transport the user 11 by referring to service data D2. The service data D2 indicates the order of the vehicles 40 to arrive at the waiting location 72, and availabilities of one or more vehicles 40 before arrival at the waiting location 72 among the plurality of vehicles 40. As illustrated in FIG. 3, data indicating “vehicle IDs”, “order of departure”, “statuses”, and “availabilities” of the vehicles V1, V2, . . . , and Vn is registered in a database 27 as the service data D2 in the example of FIG. 2. “ID” is an abbreviation for “identifier”. The order of the vehicles V1, V2, . . . , and Vn to arrive at the waiting location 72 is indicated by the “order of departure” and the “statuses”. According to the data registered in the database 27, for example, the vehicle V1 has departed from the base 71 firstly, and is currently moving from the waiting location 72 toward the destination 73. That is, the vehicle V1 has arrived at the waiting location 72 firstly. The vehicle V2 has departed from the base 71 secondly, and is currently moving from the base 71 toward the waiting location 72. That is, the vehicle V2 is scheduled to arrive at the waiting location 72 secondly. The vehicle V3 is scheduled to depart from the base 71 thirdly, and is currently on standby at the base 71. That is, the vehicle V3 is scheduled to arrive at the waiting location 72 thirdly. The vehicle V4 is scheduled to depart from the base 71 fourthly, and is currently on standby at the base 71. That is, the vehicle V4 is scheduled to arrive at the waiting location 72 fourthly. The availabilities of the vehicles V2, V3, . . . , and Vn before arrival at the waiting location 72 are indicated by the “availabilities”. According to the data registered in the database 27, for example, the vehicle V2 includes 12 riding areas including four seating areas and eight standing areas, but all the riding areas are occupied. Three standing areas out of the eight standing areas may be changed to three seating areas or assigned to a wheelchair. Each riding area is regarded as being occupied when reserved even if the passenger has not ridden the vehicle. The vehicle V3 includes 12 riding areas similarly to the vehicle V2. Seven riding areas are occupied, but five standing areas are available. The vehicle V4 includes 12 riding areas similarly to the vehicle V2. All the riding areas are available.

According to this embodiment, the vehicle to transport the user 11 can be determined based on the order of the vehicles 40 to arrive at the waiting location 72 and the availabilities of one or more vehicles 40 before arrival at the waiting location 72. Thus, convenience for the user 11 is improved.

In this embodiment, when the request data D1 is received, the service management device 20 determines whether to select, as the transportation vehicle, a first arriving vehicle 41 expected to arrive at the waiting location 72 subsequently among the plurality of vehicles 40 based on an availability of the first arriving vehicle 41. When the first arriving vehicle 41 is not selected, the service management device 20 determines whether to select, as the transportation vehicle, a second arriving vehicle 42 expected to arrive at the waiting location 72 later than the first arriving vehicle 41 among the plurality of vehicles 40 based on an availability of the second arriving vehicle 42. In the example of FIG. 2, the vehicle V2 is expected to arrive at the waiting location 72 subsequently. That is, the vehicle V2 corresponds to the first arriving vehicle 41. All the riding areas are occupied in the vehicle V2. Therefore, the service management device 20 does not select the vehicle V2. In this example, the vehicles V3, V4, . . . , and Vn are expected to arrive at the waiting location 72 later than the vehicle V2. That is, each of the vehicles V3, V4, . . . , and Vn may correspond to the second arriving vehicle 42. Among the vehicles V3, V4, . . . , and Vn, the vehicle V3 is expected to arrive at the waiting location 72 subsequently to the vehicle V2. Five standing areas are available in the vehicle V3. Therefore, the service management device 20 selects the vehicle V3 as the transportation vehicle.

According to this embodiment, when the request is made to transport the user 11 but the oncoming vehicle 40 has no available seat, the request can be fulfilled by transporting the user 11 on, for example, the subsequent vehicle 40. As a result, the user can avoid suffering inconvenience.

In this embodiment, when the first arriving vehicle 41 has departed from the base 71, the second arriving vehicle 42 is moving closer to the base 71 than the first arriving vehicle 41, or is on standby at the base 71. When the first arriving vehicle 41 is on standby at the base 71, the second arriving vehicle 42 is on standby at the base 71 and scheduled to depart later than the first arriving vehicle 41. In the example of FIG. 2, the vehicle V2 corresponds to the first arriving vehicle 41. The vehicle V2 has departed from the base 71. The vehicles V3, V4, . . . , and Vn are on standby at the base 71. Therefore, each of the vehicles V3, V4, . . . , and Vn may correspond to the second arriving vehicle 42.

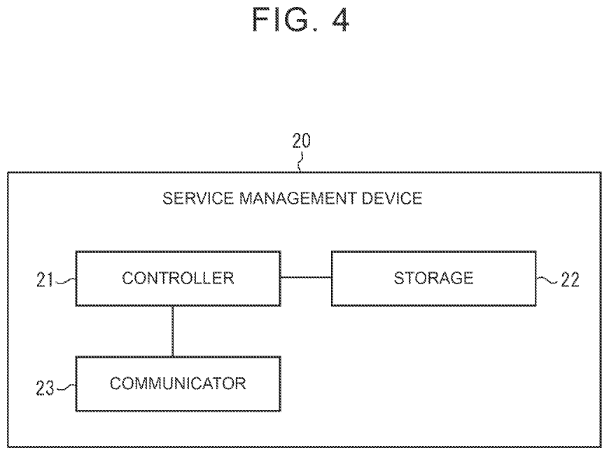

The configuration of the service management device 20 according to this embodiment is described with reference to FIG. 4.

The service management device 20 includes a controller 21, a storage 22, and a communicator 23.

The controller 21 includes at least one processor, at least one programmable circuit, at least one dedicated circuit, or any combination of those components. The processor is a general-purpose processor such as a CPU or a GPU, or a processor dedicated to specific processes. “CPU” is an abbreviation for “central processing unit”. “GPU” is an abbreviation for “graphics processing unit”. Examples of the programmable circuit include an FPGA. “FPGA” is an abbreviation for “field-programmable gate array”. Examples of the dedicated circuit include an ASIC. “ASIC” is an abbreviation for “application specific integrated circuit”. The controller 21 executes processes related to operations of the service management device 20 while controlling individual parts of the service management device 20.

The storage 22 includes at least one semiconductor memory, at least one magnetic memory, at least one optical memory, or any combination of those memories. Examples of the semiconductor memory include a RAM and a ROM. “RAM” is an abbreviation for “random access memory”. “ROM” is an abbreviation for “read only memory”. Examples of the RAM include an SRAM and a DRAM. “SRAM” is an abbreviation for “static random access memory”. “DRAM” is an abbreviation for “dynamic random access memory”. Examples of the ROM include an EEPROM. “EEPROM” is an abbreviation for “electrically erasable programmable read only memory”. For example, the storage 22 functions as a main memory, an auxiliary memory, or a cache memory. The storage 22 stores data to be used for the operations of the service management device 20, and data obtained through the operations of the service management device 20. In this embodiment, the database 27 is constructed in the storage 22. The database 27 may be constructed in an external storage and connected to the service management device 20.

The communicator 23 includes at least one communication interface. Examples of the communication interface include a LAN interface. The communicator 23 receives data to be used for the operations of the service management device 20, and transmits data obtained through the operations of the service management device 20.

Functions of the service management device 20 are implemented such that the processor serving as the controller 21 executes a service management program according to this embodiment. That is, the functions of the service management device 20 are implemented by software. The service management program causes a computer to function as the service management device 20 by causing the computer to execute the operations of the service management device 20. That is, the computer functions as the service management device 20 by executing the operations of the service management device 20 based on the service management program.

The program can be stored in a non-transitory computer-readable medium. Examples of the non-transitory computer-readable medium include a flash memory, a magnetic recording device, an optical disc, a magneto-optical recording medium, and a ROM. For example, the program is distributed by selling, transferring, or lending a portable medium such as an SD card, a DVD, or a CD-ROM that stores the program. “SD” is an abbreviation for “Secure Digital”. “DVD” is an abbreviation for “digital versatile disc”. “CD-ROM” is an abbreviation for “compact disc read only memory”. The program may be distributed by storing the program in a storage of a server and transferring the program from the server to other computers. The program may be provided as a program product.

For example, the computer temporarily stores, in the main memory, the program stored in the portable medium or transferred from the server. The computer causes the processor to read the program stored in the main memory and execute processes based on the read program. The computer may directly read the program from the portable medium and execute the processes based on the program. Every time the program is transferred from the server to the computer, the computer may sequentially execute processes based on the received program. The processes may be executed by a so-called ASP service in which the functions are implemented only by execution instructions and result acquisition without transferring the program from the server to the computer. “ASP” is an abbreviation for “application service provider”. The program includes an entity that conforms to the program and is information to be used for processes executed by an electronic computer. For example, data that is not a direct command for the computer but has a property to define computer processes corresponds to the “entity conforming to the program”.

The functions of the service management device 20 may partially or entirely be implemented by a programmable circuit or a dedicated circuit serving as the controller 21. That is, the functions of the service management device 20 may partially or entirely be implemented by hardware.

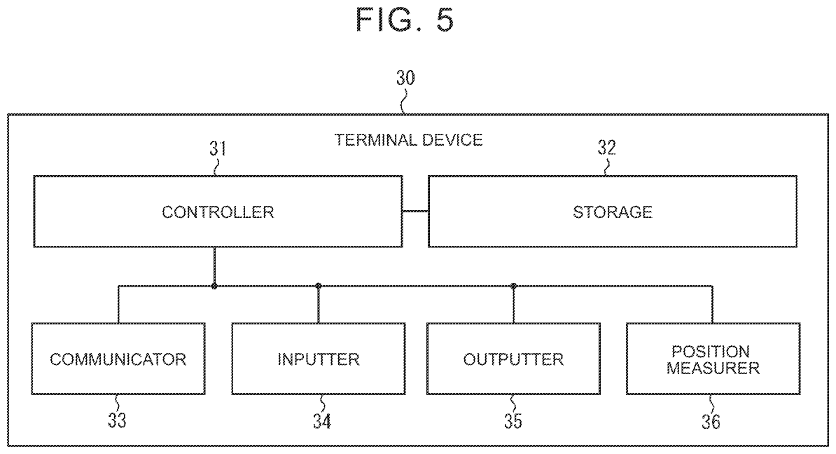

The configuration of the terminal device 30 according to this embodiment is described with reference to FIG. 5.

The terminal device 30 includes a controller 31, a storage 32, a communicator 33, an inputter 34, an outputter 35, and a position measurer 36.

The controller 31 includes at least one processor, at least one programmable circuit, at least one dedicated circuit, or any combination of those components. The processor is a general-purpose processor such as a CPU or a GPU, or a processor dedicated to specific processes. Examples of the programmable circuit include an FPGA. Examples of the dedicated circuit include an ASIC. The controller 31 executes processes related to operations of the terminal device 30 while controlling individual parts of the terminal device 30.

The storage 32 includes at least one semiconductor memory, at least one magnetic memory, at least one optical memory, or any combination of those memories. Examples of the semiconductor memory include a RAM and a ROM. Examples of the RAM include an SRAM and a DRAM. Examples of the ROM include an EEPROM. For example, the storage 32 functions as a main memory, an auxiliary memory, or a cache memory. The storage 32 stores data to be used for the operations of the terminal device 30, and data obtained through the operations of the terminal device 30.

The communicator 33 includes at least one communication interface. Examples of the communication interface include an interface conforming to a mobile communication standard such as LTE, 4G, or 5G, an interface conforming to a short-range wireless communication standard such as Bluetooth (registered trademark), and a LAN interface. “LTE” is an abbreviation for “Long Term Evolution”. “4G” is an abbreviation for “4th generation”. “5G” is an abbreviation for “5th generation”. The communicator 33 receives data to be used for the operations of the terminal device 30, and transmits data obtained through the operations of the terminal device 30.

The inputter 34 includes at least one input interface. Examples of the input interface include physical keys, capacitive keys, a pointing device, a touchscreen integrated with a display, a camera, LiDAR, and a microphone. “LiDAR” is an abbreviation for “light detection and ranging”. The inputter 34 receives an operation for inputting data to be used for the operations of the terminal device 30. The inputter 34 may be connected to the terminal device 30 as an external input device instead of being provided in the terminal device 30. Examples of a connection interface include an interface conforming to a standard such as USB, HDMI (registered trademark), or Bluetooth (registered trademark). “USB” is an abbreviation for “Universal Serial Bus”. “HDMI” (registered trademark) is an abbreviation for “High-Definition Multimedia Interface”.

The outputter 35 includes at least one output interface. Examples of the output interface include a display and a loudspeaker. Examples of the display include an LCD and an organic EL display. “LCD” is an abbreviation for “liquid crystal display”. “EL” is an abbreviation for “electro luminescence”. The outputter 35 outputs data obtained through the operations of the terminal device 30. The outputter 35 may be connected to the terminal device 30 as an external output device instead of being provided in the terminal device 30. Examples of a connection interface include an interface conforming to a standard such as USB, HDMI (registered trademark), or Bluetooth (registered trademark).

The position measurer 36 includes at least one GNSS receiver. “GNSS” is an abbreviation for “global navigation satellite system”. Examples of the GNSS include GPS, QZSS, BDS, GLONASS, and Galileo. “GPS” is an abbreviation for “Global Positioning System”. “QZSS” is an abbreviation for “Quasi-Zenith Satellite System”. A satellite in the QZSS is called “quasi-zenith satellite”. “BDS” is an abbreviation for “BeiDou Navigation Satellite System”. “GLONASS” is an abbreviation for “Global Navigation Satellite System”. The position measurer 36 measures a position of the terminal device 30.

Functions of the terminal device 30 are implemented such that the processor serving as the controller 31 executes a terminal program according to this embodiment. That is, the functions of the terminal device 30 are implemented by software. The terminal program causes a computer to function as the terminal device 30 by causing the computer to execute the operations of the terminal device 30. That is, the computer functions as the terminal device 30 by executing the operations of the terminal device 30 based on the terminal program.

The functions of the terminal device 30 may partially or entirely be implemented by a programmable circuit or a dedicated circuit serving as the controller 31. That is, the functions of the terminal device 30 may partially or entirely be implemented by hardware.

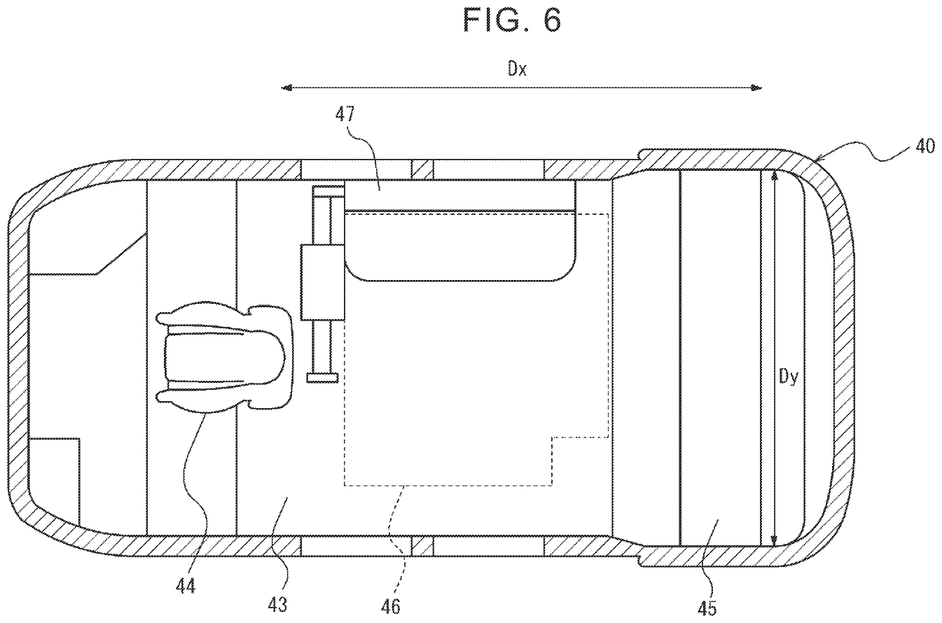

Specifications of a cabin 43 of each vehicle 40 according to this embodiment are described with reference to FIG. 6.

Although each vehicle 40 is the AV, the vehicle 40 may be driven manually. Therefore, a driver's seat 44 is provided at the front of the cabin 43. A space for passengers to ride the vehicle 40 is provided at the rear and center of the cabin 43. A dimension Dx of the space in a length direction and a dimension Dy of the space in a width direction may be any dimensions. In this embodiment, the dimension Dx and the dimension Dy are 2600 millimeters and 1860 millimeters, respectively. At the rear of the cabin 43, a seat 45 is provided as four seating areas. At the center of the cabin 43, a standing space 46 is provided as eight standing areas. At the side of the cabin 43, a foldable seat 47 is provided as three additional seating areas. When the foldable seat 47 is unfolded, three seating areas are added in place of three standing areas. The three standing areas may be assigned to a wheelchair. That is, a part of the standing space 46 can be used selectively for the three standing areas, the three seating areas, or the wheelchair.

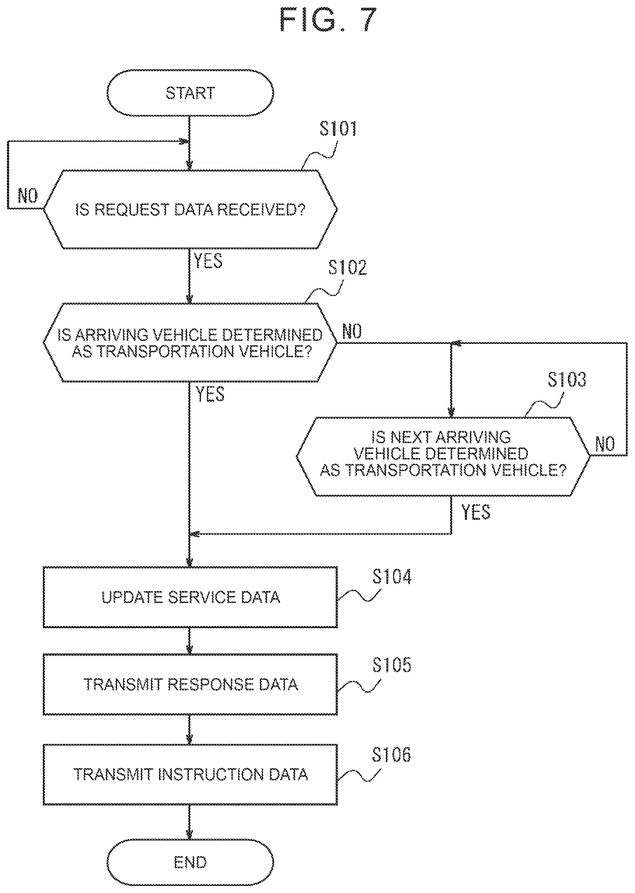

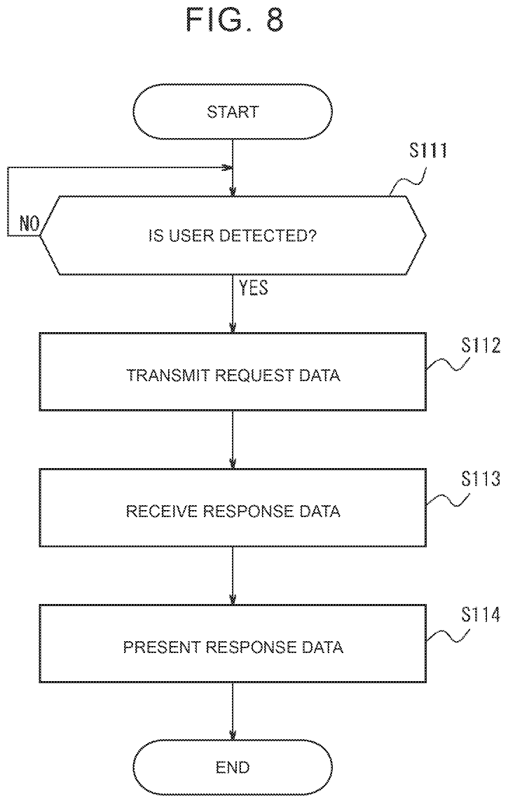

Operations of the system 10 according to this embodiment are described with reference to FIG. 7 and FIG. 8. The operations correspond to a service management method according to this embodiment. FIG. 7 illustrates the operations of the service management device 20. FIG. 8 illustrates the operations of the terminal device 30.

In Step S111 of FIG. 8, the controller 31 of the terminal device 30 detects at least one user 11. Any method may be used as a method for detecting the user 11. This embodiment uses a method involving determining whether any user 11 is waiting at the waiting location 72 by analyzing an image acquired by the camera or LiDAR serving as the inputter 34 of the terminal device 30. A known method may be used as a method for analyzing the image. Machine learning such as deep learning may be used. In the example of FIG. 2, when the user U1 stands in front of the digital signage serving as the terminal device 30, the controller 31 detects the user U1 by analyzing an image captured by the camera serving as the inputter 34.

As another method for detecting the user 11, a method involving detecting a human body by using a load sensor installed on a road may be used to achieve detection that is not affected by weather or time frames. Alternatively, there may be used a method involving receiving an operation for expressing intention to ride a vehicle, such as depression of or touch on a “ride” button, from the user 11 via the inputter 34 of the terminal device 30. In a case where the terminal device 30 is held by the user 11 instead of being installed at the bus stop as one modified example of this embodiment, there may be used a method involving determining whether the user 11 is waiting at the waiting location 72 based on whether a position measured by the position measurer 36 of the terminal device 30 agrees with the waiting location 72.

When the user 11 is detected in Step S111 of FIG. 8, the controller 31 of the terminal device 30 causes the communicator 33 to transmit request data D1 in Step S112. The request data D1 indicates a request to transport the user 11. The communicator 33 transmits the request data D1 to the service management device 20.

In Step S101 of FIG. 7, the communicator 23 of the service management device 20 receives, from the terminal device 30, the request data D1 transmitted in Step S112 of FIG. 8. The controller 21 of the service management device 20 acquires the request data D1 received by the communicator 23.

When the request data D1 is received in Step S101 of FIG. 7, that is, the request data. D1 is acquired, the controller 21 of the service management device 20 determines a transportation vehicle to transport the user 11 by referring to service data D2 in Step S102 or Step S103. The service data D2 indicates the order of the vehicles 40 to arrive at the waiting location 72, and availabilities of one or more vehicles 40 before arrival at the waiting location 72 among the plurality of vehicles 40.

Specifically, in Step S102 of FIG. 7, the controller 21 of the service management device 20 determines whether to select, as the transportation vehicle, the first arriving vehicle 41 expected to arrive at the waiting location 72 subsequently among the plurality of vehicles 40 based on the availability of the first arriving vehicle 41. When the first arriving vehicle 41 is selected, the process of Step S103 is skipped. When the first arriving vehicle 41 is not selected, the process of Step S103 is executed. In Step S103, the controller 21 determines whether to select, as the transportation vehicle, the second arriving vehicle 42 expected to arrive at the waiting location 72 later than the first arriving vehicle 41 among the plurality of vehicles 40 based on the availability of the second arriving vehicle 42. In this embodiment, when two or more vehicles 40 correspond to the second arriving vehicle 42, the controller 21 selects, as the transportation vehicle, a vehicle 40 expected to arrive at the waiting location 72 earliest among the vehicles 40 as long as the availability permits. In the example of FIG. 2, the controller 21 refers to the database 27 to identify, as the first arriving vehicle 41, the vehicle V2 expected to arrive at the waiting location 72 subsequently, but does not select the vehicle V2 because the vehicle V2 has no available riding area remaining for the user U1. The controller 21 refers to the database 27 to identify, as the second arriving vehicle 42, the vehicle V3 expected to arrive at the waiting location 72 subsequently to the vehicle V2. The controller 21 selects the vehicle V3 as the transportation vehicle because the vehicle V3 has an available riding area remaining for the user U1 if the user U1 accepts standing.

When any one of the vehicles 40 is determined as the transportation vehicle in Step S102 or Step S103 of FIG. 7, the controller 21 of the service management device 20 updates the service data D2 for an availability of the transportation vehicle in Step S104. In the example of FIG. 2, the controller 21 updates the data registered in the database 27 for the “availability” of the vehicle V3. As a result, one standing area in the vehicle V3 is assigned to the user U1, and the available riding areas in the vehicle V3 decrease from five standing areas to four standing areas.

In Step S105 of FIG. 7, the controller 21 of the service management device 20 causes the communicator 23 to transmit response data D3. When the first arriving vehicle 41 is determined as the transportation vehicle in Step S102, the response data D3 indicates an instruction to wait for the first arriving vehicle 41 at the waiting location 72. The response data D3 may include data for uniquely identifying the first arriving vehicle 41, such as a vehicle ID of the first arriving vehicle 41. The response data D3 may include data for notifying the user about a time of arrival of the first arriving vehicle 41 at the waiting location 72. When the second arriving vehicle 42 is determined as the transportation vehicle in Step S103, the response data D3 indicates an instruction to wait for the second arriving vehicle 42 at the waiting location 72. The response data D3 may include data for uniquely identifying the second arriving vehicle 42, such as a vehicle ID of the second arriving vehicle 42. The response data D3 may include data for notifying the user about a time of arrival of the second arriving vehicle 42 at the waiting location 72. The communicator 23 transmits the response data D3 to the terminal device 30.

In Step S113 of FIG. 8, the communicator 33 of the terminal device 30 receives, from the service management device 20, the response data D3 transmitted in Step S105 of FIG. 7. The controller 31 of the terminal device 30 acquires the response data D3 received by the communicator 33.

In Step S114 of FIG. 8, the controller 31 of the terminal device 30 presents the response data D3 acquired in Step S113 to the user 11. Any method may be used as a method for presenting the response data D3 to the user 11. This embodiment uses a method involving displaying details of the response data D3 on the display serving as the outputter 35 of the terminal device 30, a method involving outputting voice indicating the details of the response data D3 from the loudspeaker serving as the outputter 35, or both of the methods. In the example of FIG. 2, the controller 31 presents, to the user U1 via the display or the loudspeaker, a message for prompting the user U1 to wait for the vehicle V3 at the waiting location 72. The controller 31 may further present, to the user U1 via the display or the loudspeaker, information for uniquely identifying the vehicle V3, such as a vehicle ID of the vehicle V3. The controller 31 may notify the user U1 about a time of arrival of the vehicle V3 at the waiting location 72 via the display or the loudspeaker.

In Step S106 of FIG. 7, the controller 21 of the service management device 20 causes the communicator 23 to transmit instruction data D4. When a vehicle 40 on standby at the base 71 is determined as the transportation vehicle in Step S102 or Step S103, the instruction data D4 indicates an instruction to depart from the base 71. The instruction data D4 may include data indicating an instruction to stop at the waiting location 72 after the departure from the base 71. When a vehicle 40 that has departed from the base 71 is determined as the transportation vehicle in Step S102 or Step S103, the instruction data D4 need not be transmitted. When the instruction data D4 is transmitted, the instruction data D4 may include data indicating an instruction to stop at the waiting location 72. The communicator 23 transmits the instruction data D4 to the transportation vehicle determined in Step S102 or Step S103. In the example of FIG. 2, the communicator 23 transmits the instruction data D4 to the vehicle V3. When the instruction data D4 is received, the vehicle V3 departs from the base 71 based on the received instruction data D4. The vehicle V3 moves toward the waiting location 72 and stops at the waiting location 72. The user U1 gets on the vehicle V3 at the waiting location 72. The vehicle V3 moves toward the destination 73 and stops at the destination 73. The user U1 gets off the vehicle V3 at the destination 73.

As described above, the communicator 23 of the service management device 20 in this embodiment receives, from the terminal device 30, the request data D1 indicating the request to transport the at least one user 11. When the request data D1 is received by the communicator 23, the controller 21 of the service management device 20 determines the transportation vehicle to transport the at least one user 11 by referring to the service data D2 indicating the order in which the vehicles 40 sequentially departing from the base 71 and moving toward the common destination 73 are expected to arrive at the waiting location 72 where the at least one user 11 is waiting, and the availabilities of one or more vehicles 40 before arrival at the waiting location 72 among the plurality of vehicles 40. According to this embodiment, the convenience for the user 11 is improved.

The at least one user 11 is not limited to one user, and may be a plurality of users. The controller 21 of the service management device 20 may determine one of the vehicles 40 as a transportation vehicle that collectively transports the users, or may determine two or more vehicles 40 out of the plurality of vehicles 40 as transportation vehicles that transport the users in separate groups.

In this embodiment, the location where the user 11 gets off the transportation vehicle, that is, the destination of the user 11 is identical to the destination 73 of the vehicles 40. As one modified example of this embodiment, the destination of the user 11 may arbitrarily be designated by the user 11. When the vehicles 40 move along a predetermined route from the base 71 to the destination 73, the destination of the user 11 may be limited to any location between the waiting location 72 and the destination 73 on the route. In this modified example, the request data D1 may include data for designating the destination of the user 11. In Step S111 of FIG. 8, the controller 31 of the terminal device 30 may receive an operation for designating the destination of the user 11 from the user 11 via the inputter 34. In a case where the destination of the user 11 is preregistered in the system 10 in association with the user 11, the controller 31 may determine the corresponding destination when the user 11 is detected. The instruction data D4 may include data indicating an instruction to stop at the destination of the user 11 after the departure from the waiting location 72.

As one modified example of this embodiment, the request data D1 may include data indicating an attribute or situation of the user 11. Examples of the attribute include sex, age, height, weight, or any combination of those properties. The attribute may include information indicating whether the user 11 wants to be seated. Examples of the situation include weather such as rain or snow, information indicating whether the user 11 is in a hurry, information indicating whether the user 11 is carrying baggage, information indicating whether the user 11 wears high-heeled shoes, information indicating whether the user 11 accompanies a child, or any combination of those pieces of information. In Step S111 of FIG. 8, the controller 31 of the terminal device 30 may detect the attribute or situation of the user 11 by analyzing an image acquired by the camera or LiDAR serving as the inputter 34. Alternatively, the controller 31 may receive an operation for inputting the attribute or situation of the user 11 from the user 11 via the inputter 34. In a case where the attribute or situation of the user 11 is preregistered in the system 10 in association with the user 11, the controller 31 may determine the corresponding attribute or situation when the user 11 is detected. In Step S102 or Step S103 of FIG. 7, the controller 21 of the service management device 20 may determine the transportation vehicle by referring not only to the service data D2 but also to the request data D1. Specifically, in Step S102, the controller 21 may determine whether to select the first arriving vehicle 41 as the transportation vehicle based on the availability of the first arriving vehicle 41 and the attribute or situation of the user 11. When the first arriving vehicle 41 is not selected, the controller 21 may determine, in Step S103, whether to select the second arriving vehicle 42 as the transportation vehicle based on the availability of the second arriving vehicle 42 and the attribute or situation of the user 11.

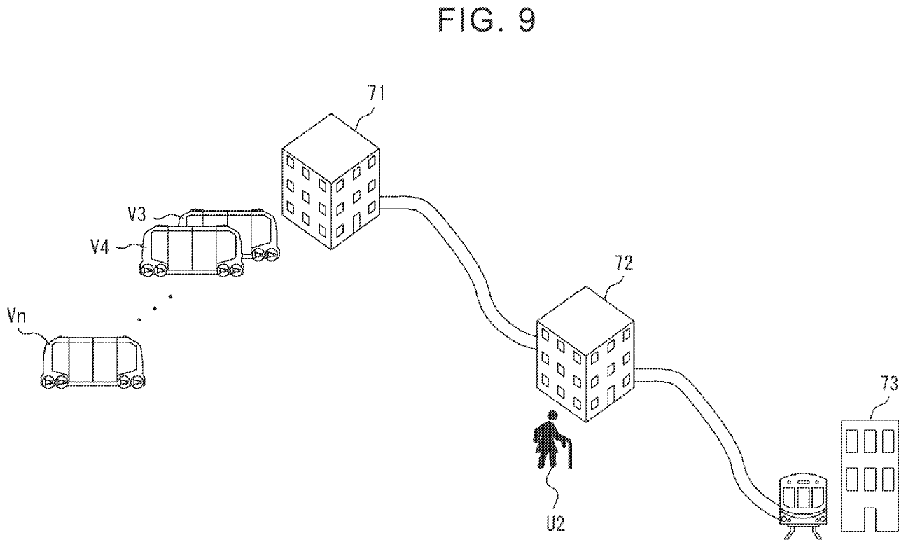

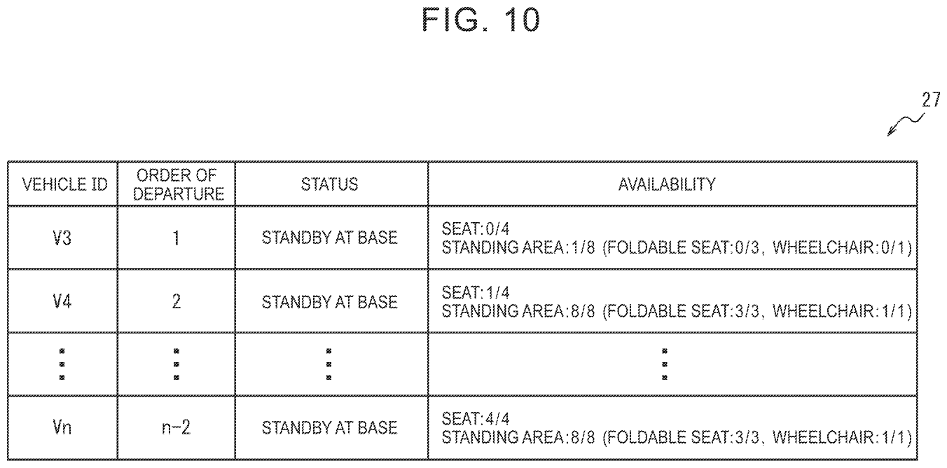

Details of this modified example are described with reference to FIG. 9 and FIG. 10. Regarding features in common with those in the example of FIG. 2, description is omitted or simplified as appropriate.

In the example of FIG. 9, a user U2 who is a visitor in the smart city serving as the user 11 is waiting for a bus at the waiting location 72 to go home from the smart city. The user U2 is so elderly that the user U2 cannot keep standing on the bus.

As illustrated in FIG. 10, data indicating “vehicle IDs”, “order of departure”, “statuses”, and “availabilities” of the vehicles V3, V4, . . . , and Vn is registered in the database 27 as the service data D2 in the example of FIG. 9. The order of the vehicles V3, V4, . . . , and Vn to arrive at the waiting location 72 is indicated by the “order of departure” and the “statuses”. According to the data registered in the database 27, for example, the vehicle V3 is scheduled to depart from the base 71 firstly, and is currently on standby at the base 71. That is, the vehicle V3 is scheduled to arrive at the waiting location 72 firstly. The vehicle V4 is scheduled to depart from the base 71 secondly, and is currently on standby at the base 71. That is, the vehicle V4 is scheduled to arrive at the waiting location 72 secondly. The availabilities of the vehicles V3, V4, . . . , and Vn before arrival at the waiting location 72 are indicated by the “availabilities”. According to the data registered in the database 27, for example, the vehicle V3 includes 12 riding areas including four seating areas and eight standing areas, and 11 riding areas are occupied with one standing area available. The vehicle V4 includes 12 riding areas similarly to the vehicle V3. Three riding areas are occupied, but one seating area and eight standing areas are available.

In the example of FIG. 9, the vehicle V3 is expected to arrive at the waiting location 72 subsequently. In the vehicle V3, one standing area is available, but all the seating areas are occupied. Therefore, the service management device 20 does not select the vehicle V3. In this example, the vehicle V4 is expected to arrive at the waiting location 72 subsequently to the vehicle V3. One seating area is available in the vehicle V4. Therefore, the service management device 20 selects the vehicle V4 as the transportation vehicle. The service management device 20 updates the data registered in the database 27 for the “availability” of the vehicle V4. As a result, the one seating area in the vehicle V4 is assigned to the user U2, and the available riding areas in the vehicle V4 decrease to eight standing areas.

According to this modified example, the vehicle to transport the user 11 can be determined based also on the situation or attribute such as the age of the user 11. Thus, the convenience for the user 11 is further improved.

As one modified example of this embodiment, the request data D1 may include data indicating a user count. In Step S111 of FIG. 8, the controller 31 of the terminal device 30 may detect the user count by analyzing an image acquired by the camera or LiDAR serving as the inputter 34. Alternatively, the controller 31 may receive an operation for inputting the user count from the user 11 via the inputter 34. In a case where the user count is preregistered in the system 10 in association with the user 11, the controller 31 may determine the corresponding user count when the user 11 is detected. In Step S102 or Step S103 of FIG. 7, the controller 21 of the service management device 20 may determine the transportation vehicle by referring not only to the service data D2 but also to the request data D1. Specifically, when the at least one user 11 is a plurality of users and the first arriving vehicle 41 has an availability for a part of the users, the controller 21 may determine the first arriving vehicle 41 and the second arriving vehicle 42 as transportation vehicles.

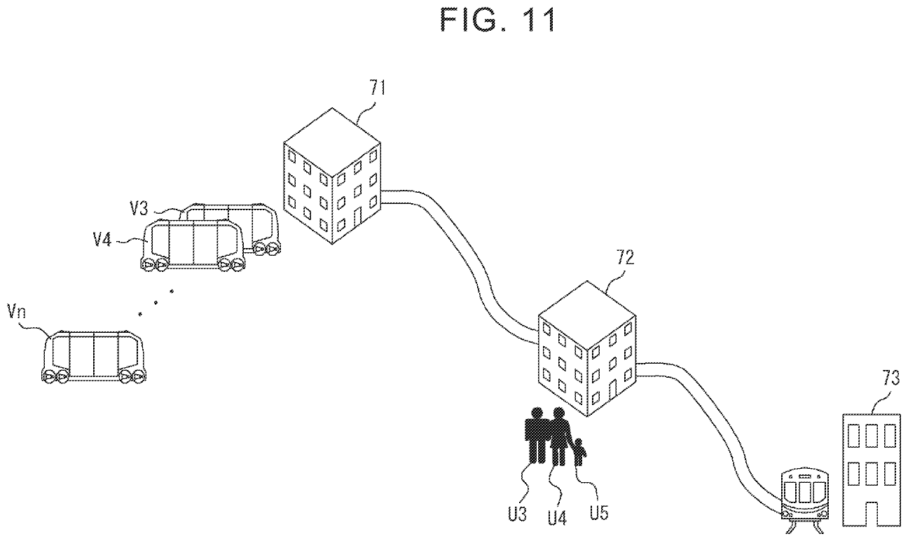

Details of this modified example are described with reference to FIG. 10 and FIG. 11. Regarding features in common with those in the example of FIG. 9, description is omitted or simplified as appropriate.

In the example of FIG. 11, users U3, U4, and U5 who are residents in the smart city serving as the plurality of users are waiting for a bus at the waiting location 72 to go out for a family trip.

In the example of FIG. 11, the vehicle V3 is expected to arrive at the waiting location 72 subsequently as in the example of FIG. 9. One standing area is available in the vehicle V3. Therefore, the service management device 20 selects the vehicle V3 as the transportation vehicle. In this example, the vehicle V4 is expected to arrive at the waiting location 72 subsequently to the vehicle V3. One seating area and eight standing areas are available in the vehicle V4. Therefore, the service management device 20 also selects the vehicle V4 as the transportation vehicle. The service management device 20 updates the data registered in the database 27 for the “availabilities” of the vehicles V3 and V4. As a result, the one standing area in the vehicle V3 is assigned to the user U3, and the vehicle V3 has no available riding area. One standing area and the one seating area in the vehicle V4 are assigned to the users U4 and U5, and the available riding areas in the vehicle V4 decrease to seven standing areas.

According to this modified example, the vehicle to transport the user 11 can be determined based also on the user count. Thus, the convenience for the user 11 is further improved.

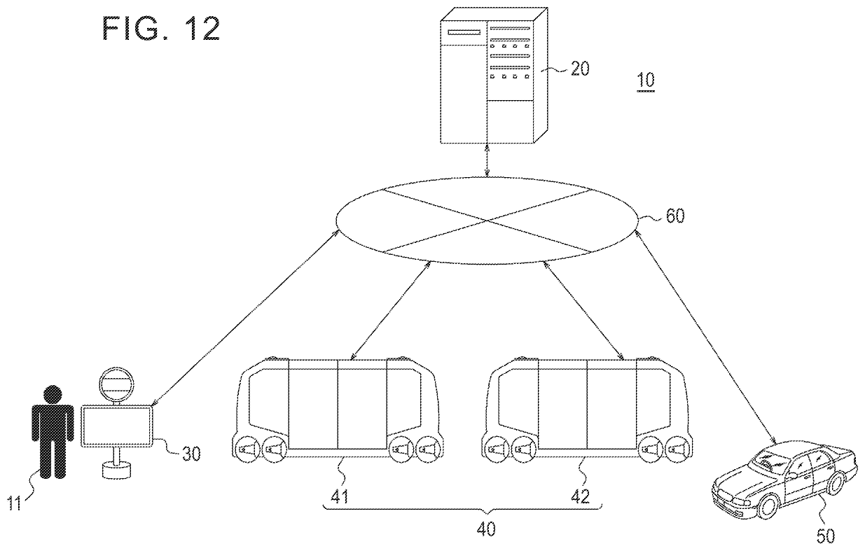

The configuration of a system 10 according to one modified example of this embodiment is described with reference to FIG. 12.

The system 10 according to this modified example further includes at least one shareable vehicle 50. The service management device 20 is communicable with the shareable vehicle 50 via the network 60. The terminal device 30 may be communicable with the shareable vehicle 50 via the network 60.

The shareable vehicle 50 is any type of automobile such as a gasoline vehicle, a diesel vehicle, an HV, a PHV, an EV, or an FCV In this modified example, the shareable vehicle 50 is an AV, but may be driven by a driver, or driving may be automated at any level. For example, the automation level is any one of Level 1 to Level 5 defined by SAE. The shareable vehicle 50 may be a MaaS vehicle.

The shareable vehicle 50 differs from the vehicles 40, and moves toward each individual destination.

In this modified example, when the first arriving vehicle 41 is not selected, the service management device 20 determines whether to select the shareable vehicle 50 as the transportation vehicle. Specifically, when the first arriving vehicle 41 is not selected, the service management device 20 determines the shareable vehicle 50 as the transportation vehicle irrespective of the attribute and situation of the user 11. The service management device 20 may determine whether to select the shareable vehicle 50 as the transportation vehicle based on the attribute or situation of the user 11. For example, the service management device 20 may recommend the shareable vehicle 50 on a rainy or snowy day or to a person in a hurry, carrying baggage, wearing high-heeled shoes, or accompanying a child. When the shareable vehicle 50 is not selected, the service management device 20 may determine whether to select the second arriving vehicle 42 as the transportation vehicle based on the availability of the second arriving vehicle 42.

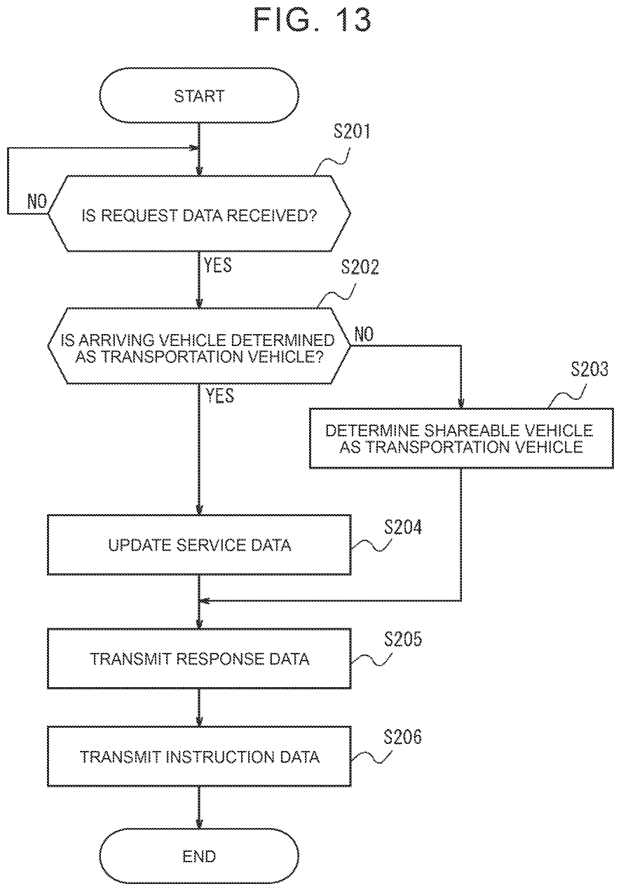

Operations of the system 10 according to this modified example are described with reference to FIG. 13. The operations correspond to a service management method according to this modified example. FIG. 13 illustrates operations of the service management device 20. Operations of the terminal device 30 are identical to those illustrated in FIG. 8, and their description is therefore omitted.

Processes of Step S201 and Step S202 of FIG. 13 are identical to the processes of Step S101 and Step S102 of FIG. 7, and their description is therefore omitted. Processes of Step S204 to Step S206 of FIG. 13 when the first arriving vehicle 41 is determined as the transportation vehicle in Step S202 are identical to the processes of Step S104 to Step S106 of FIG. 7 when the first arriving vehicle 41 is determined as the transportation vehicle in Step S102. Therefore, description of the processes is omitted.

When the first arriving vehicle 41 is not selected in Step S202 of FIG. 13, the controller 21 of the service management device 20 selects the shareable vehicle 50 as the transportation vehicle in Step S203.

In Step S205 of FIG. 13, the controller 21 of the service management device 20 causes the communicator 23 to transmit response data D3. When the shareable vehicle 50 is determined as the transportation vehicle in Step S203, the response data D3 indicates an instruction to move from the waiting location 72 toward a riding location where the user 11 is expected to get in the shareable vehicle 50. Assuming that the waiting location 72 is the bus stop in the smart city as in the example of FIG. 2, the riding location is, for example, an underground vehicle waiting place in the smart city, or a place where the shareable vehicle 50 is left after driving in the smart city. The response data D3 may include data for uniquely identifying the shareable vehicle 50, such as a vehicle ID of the shareable vehicle 50. The response data D3 may include an electronic key necessary to ride the shareable vehicle 50. The communicator 23 transmits the response data D3 to the terminal device 30.

In Step S206 of FIG. 13, the controller 21 of the service management device 20 causes the communicator 23 to transmit instruction data D4. When the shareable vehicle 50 is determined as the transportation vehicle in Step S203, the instruction data D4 indicates an instruction to move toward the riding location. The communicator 23 transmits the instruction data. D4 to the transportation vehicle.

As a further modified example, the user 11 may get in the shareable vehicle 50 at the waiting location 72 instead of the riding location. In this modified example, the response data D3 indicates an instruction to wait for the shareable vehicle 50 at the waiting location 72. The response data D3 may include data for notifying the user about a time of arrival of the shareable vehicle 50 at the waiting location 72. The instruction data D4 indicates an instruction to move toward the waiting location 72.

As a further modified example, the request data D1 may include data indicating a user count. In Step S111 of FIG. 8, the controller 31 of the terminal device 30 may detect the user count by analyzing an image acquired by the camera or LiDAR serving as the inputter 34. Alternatively, the controller 31 may receive an operation for inputting the user count from the user 11 via the inputter 34. In a case where the user count is preregistered in the system 10 in association with the user 11, the controller 31 may determine the corresponding user count when the user 11 is detected. In Step S202 or Step S203 of FIG. 13, the controller 21 of the service management device 20 may determine the transportation vehicle by referring not only to the service data D2 but also to the request data D1. Specifically, when the at least one user 11 is a plurality of users and the first arriving vehicle 41 has an availability for a part of the users, the controller 21 may determine the first arriving vehicle 41 and the shareable vehicle 50 as transportation vehicles.

When the individual destination is identical to the common destination 73 and the shareable vehicle 50 is left at the individual destination after driving, the shareable vehicle 50 may autonomously move to follow a vehicle 40 that has arrived at the common destination 73 among the plurality of vehicles 40. For example, when the shareable vehicle 50 is left at a railroad station or any other place outside the smart city after driving, the shareable vehicle 50 may autonomously move toward the smart city by following any one of the vehicles 40, and autonomously return to the underground vehicle waiting place when the shareable vehicle 50 enters the smart city.

The present disclosure is not limited to the embodiment described above. For example, two or more blocks in the block diagram may be integrated together, or one block may be divided apart. Two or more steps in the flowchart may be executed in parallel or in different order as necessary or based on processing capacities of devices that execute the steps, instead of being executed in time series in accordance with description. Other modifications may be made without departing from the gist of the present disclosure.

What is claimed is:

1. A service management device comprising:
a communicator configured to receive, from a terminal device, request data indicating a request to transport a user; and
a controller configured to, when the request data is received by the communicator, determine a transportation vehicle configured to transport the user by referring to service data, wherein
the service data indicates
order in which a plurality of vehicles configured to sequentially depart from a base and move toward a common destination is expected to arrive at a waiting location where the user is waiting, and
an availability of a vehicle before arrival at the waiting location among the plurality of vehicles.

2. The service management device according to claim 1, wherein the controller is configured to update the service data for an availability of the transportation vehicle when any one of the vehicles is determined as the transportation vehicle.

3. The service management device according to claim 1, wherein the controller is configured to:
when the request data is received by the communicator, determine whether the controller selects a first arriving vehicle as the transportation vehicle, the first arriving vehicle being a vehicle expected to arrive at the waiting location subsequently among the plurality of vehicles based on an availability of the first arriving vehicle; and
when the controller does not select the first arriving vehicle, determine whether the controller selects a second arriving vehicle as the transportation vehicle, the second arriving vehicle being a vehicle expected to arrive at the waiting location later than the first arriving vehicle among the plurality of vehicles based on an availability of the second arriving vehicle.

4. The service management device according to claim 3, wherein:
when the first arriving vehicle has departed from the base, the second arriving vehicle is moving closer to the base than the first arriving vehicle, or is on standby at the base; and
when the first arriving vehicle is on standby at the base, the second arriving vehicle is on standby at the base and scheduled to depart later than the first arriving vehicle.

5. The service management device according to claim 3, wherein the communicator is configured to, when a vehicle on standby at the base is determined as the transportation vehicle by the controller, transmit instruction data to the transportation vehicle, the instruction data being data indicating an instruction to depart from the base.

6. The service management device according to claim 3, wherein the controller is configured to determine the first arriving vehicle and the second arriving vehicle as a plurality of the transportation vehicles when a plurality of users including the user is present and the first arriving vehicle has an availability for a part of the users.

7. The service management device according to claim 1, wherein the controller is configured to:
when the request data is received by the communicator, determine whether the controller selects an arriving vehicle as the transportation vehicle, the arriving vehicle being a vehicle expected to arrive at the waiting location subsequently among the plurality of vehicles based on an availability of the arriving vehicle; and
when the controller does not select the arriving vehicle, determine whether the controller selects a shareable vehicle as the transportation vehicle, the shareable vehicle being different from the vehicles and configured to move toward an individual destination.

8. The service management device according to claim 7, wherein the communicator is configured to, when the shareable vehicle is determined as the transportation vehicle by the controller, transmit response data to the terminal device, the response data being data indicating an instruction to move from the waiting location toward a riding location where the user is expected to get in the shareable vehicle.

9. The service management device according to claim 7, wherein the communicator is configured to, when the shareable vehicle is determined as the transportation vehicle by the controller, transmit, to the transportation vehicle, instruction data indicating an instruction to move toward the waiting location.

10. The service management device according to claim 7, wherein the controller is configured to determine the arriving vehicle and the shareable vehicle as the transportation vehicles when a plurality of users including the user is present and the arriving vehicle has an availability for a part of the users.

11. A service management system comprising:
a terminal device;
a plurality of vehicles configured to sequentially depart from a base and move toward a common destination; and
a service management device including
a communicator configured to receive, from the terminal device, request data indicating a request to transport a user, and
a controller configured to, when the request data is received by the communicator, determine a transportation vehicle configured to transport the user by referring to service data, wherein
the service data indicates
order in which the vehicles configured to sequentially depart from the base and move toward the common destination are expected to arrive at a waiting location where the user is waiting, and
an availability of a vehicle before arrival at the waiting location among the plurality of vehicles.

12. The service management system according to claim 11, further comprising a shareable vehicle different from the vehicles and configured to move toward an individual destination, wherein the controller is configured to:
when the request data is received by the communicator, determine whether the controller selects an arriving vehicle as the transportation vehicle, the arriving vehicle being a vehicle expected to arrive at the waiting location subsequently among the plurality of vehicles based on an availability of the arriving vehicle; and
when the controller does not select the arriving vehicle, determine whether the controller selects the shareable vehicle as the transportation vehicle.

13. The service management system according to claim 12, wherein the shareable vehicle is configured to, when the individual destination is identical to the common destination and the shareable vehicle is left at the individual destination after driving, autonomously move to follow a vehicle that has arrived at the common destination among the plurality of vehicles.

14. The service management system according to claim 11, wherein the terminal device is configured to transmit the request data to the service management device when the user is detected at the waiting location.

15. A service management method comprising:
transmitting, from a terminal device to a service management device, request data indicating a request to transport a user; and
determining, when the request data is received by the service management device, a transportation vehicle configured to transport the user by referring to service data, wherein the service data indicates:
order in which a plurality of vehicles configured to sequentially depart from a base and move toward a common destination is expected to arrive at a waiting location where the user is waiting; and
an availability of a vehicle before arrival at the waiting location among the plurality of vehicles.

16. The service management method according to claim 15, further comprising updating the service data for an availability of the transportation vehicle when one of the vehicles is determined as the transportation vehicle.

17. The service management method according to claim 15, wherein the determining the transportation vehicle has:
determining, when the request data is received by the service management device, whether to select a first arriving vehicle as the transportation vehicle, the first arriving vehicle being a vehicle expected to arrive at the waiting location subsequently among the plurality of vehicles based on an availability of the first arriving vehicle; and
determining, when the first arriving vehicle is not selected, whether to select a second arriving vehicle as the transportation vehicle, the second arriving vehicle being a vehicle expected to arrive at the waiting location later than the first arriving vehicle among the plurality of vehicles based on an availability of the second arriving vehicle.

18. The service management method according to claim 17, wherein:
when the first arriving vehicle has departed from the base, the second arriving vehicle is moving closer to the base than the first arriving vehicle, or is on standby at the base; and
when the first arriving vehicle is on standby at the base, the second arriving vehicle is on standby at the base and scheduled to depart later than the first arriving vehicle.

19. The service management method according to claim 15, wherein the determining the transportation vehicle has:
determining, when the request data is received by the service management device, whether to select an arriving vehicle as the transportation vehicle, the arriving vehicle being a vehicle expected to arrive at the waiting location subsequently among the plurality of vehicles based on an availability of the arriving vehicle; and
determining, when the arriving vehicle is not selected, whether to select a shareable vehicle as the transportation vehicle, the shareable vehicle being different from the vehicles and configured to move toward an individual destination.

20. The service management method according to claim 16, wherein the determining the transportation vehicle has:
determining, when the request data is received by the service management device, whether to select an arriving vehicle as the transportation vehicle, the arriving vehicle being a vehicle expected to arrive at the waiting location subsequently among the plurality of vehicles based on an availability of the arriving vehicle; and
determining, when the arriving vehicle is not selected, whether to select a shareable vehicle as the transportation vehicle, the shareable vehicle being different from the vehicles and configured to move toward an individual destination.
